(19) United States
(12) Patent Application Publication
(10) Pub. No.: US 2025/0364933 A1
(43) Pub. Date: Nov. 27, 2025

(54) METHOD, CONTROLLER AND COMPUTER PROGRAM FOR OPERATING AN INVERTER, AND INVERTER SYSTEM

(71) Applicant: ABB Schweiz AG, Baden (CH)

(72) Inventors: Joni Heikkila, Helsinki (FI); Tuomas Pulli, Helsinki (FI); Ville Pirsto, Helsinki (FI)

(21) Appl. No.: 19/182,238

(22) Filed: Apr. 17, 2025

(30) Foreign Application Priority Data
May 23, 2024 (EP) 24177588.1

(51) Int. Cl. H02P 21/22; H02P 27/12

(52) U.S. Cl. CPC H02P 21/22; H02P 27/12; H02P 2201/03

(57) ABSTRACT

A method for operating an inverter configured to drive a generator is provided. The inverter comprises a direct current link (DC-link) having a DC-link capacitor, and the inverter is configured to convert a three-phase alternating current (AC) voltage generated by the generator into a DC-link voltage to be applied to the DC-link capacitor. The method includes receiving a DC-link voltage reference to be applied to the DC-link, receiving an actual DC-link voltage currently present over the DC-link, determining a stator parameter reference based on the received DC-link voltage reference and the received actual DC-link voltage, modifying the determined stator parameter reference by adding a dynamic stabilizing term to the stator parameter reference, generating a switching signal for the inverter based on the modified stator parameter reference, and operating the inverter by supplying the switching signal to the inverter.

### CROSS-REFERENCE TO RELATED APPLICATIONS

This application claims priority to European Patent Application No. 24177588.1, filed May 23, 2024 and titled “METHOD, CONTROLLER AND COMPUTER PROGRAM FOR OPERATING AN INVERTER, AND INVERTER SYSTEM”, the entire contents of which are hereby incorporated by reference.

### TECHNICAL FIELD

The present disclosure relates to the field of electrical inverters. In particular, the present disclosure relates to a method, a controller, and a computer program for operating an inverter for driving a generator, and to an inverter system comprising the controller. Further, the present disclosure relates to a computer-readable medium on which the computer program is stored.

### BACKGROUND

An inverter for driving a generator typically comprises a DC-link having a DC-link capacitor, a DC terminal for being connected to a DC device or a DC grid, an AC terminal coupled to the generator, and a set of semiconductor switches and for converting a three-phase AC voltage generated by the generator into a DC-link voltage applied to the DC-link capacitor.

Applications where the DC-link voltage is controlled by an inverter driven generator are becoming more common, for example for supplying energy to a DC grid of a ship or an electric vehicle, such as a train, e.g. a tram or subway, or for converting electric energy generated by a wind turbine. In these cases, a fast response of the DC-link voltage control is expected in order to avoid too high or too low DC-link voltages in case of rapid load variations. This fast response may be achieved by providing a high proportional gain to the DC voltage controller of the inverter. However, there are cases in which a high proportional gain cannot be used, e.g., at a high load, in particular when an inductance of the inverter is large or when a capacitance C of the DC capacitor is small, as explained in the following:

The voltage over the DC-link capacitor U_{C} is related to the current I_{C} through the DC-link capacitor by:

$$C \frac{d {U}_{C}}{d t} = {I}_{C} \qquad ( 1 )$$

where C is the capacitance of the DC-link capacitor.

The current I_{C} through the DC-link capacitor may be expressed as function of a power P_{C} of the DC-link capacitor and the DC-link voltage U_{C} over the DC-link capacitor:

$${I}_{C} = \frac{{P}_{C}}{{U}_{C}} \qquad ( 2 )$$

By inserting equation 2 into equation 1 and by simplifying a relation between the square of the DC-link voltage U_{C} and the power P_{C} of the DC-link capacitor it is found that

$$\frac{C}{2} \frac{d {U}_{C}^{2}}{d t} = {P}_{C} \qquad ( 3 )$$

Assuming that the inverter is supplying, in other words charging, the DC-link and that an external device, such as a load, e.g., a motor driven by an external inverter, is discharging the DC-link it can be derived that

$${P}_{C} = - {P}_{I N V E R T E R} - {P}_{L O A D} \qquad ( 4 )$$

where P_{INVERTER} is the power of the inverter and P_{LOAD} is the power of the external device.

Assuming that the power of the inverter is the power of a non-salient permanent magnet machine P_{INVERTER} is given by:

$${P}_{INVERTER} = {U}_{D} {I}_{D} + {U}_{Q} {I}_{Q} \qquad ( 5 )$$

where U_{D} and U_{Q} are the stator voltage components and I_{D} and I_{Q} are the stator current components in the synchronous reference frame, in other words in the dq-frame.

Under the assumption that the d-axis is aligned with the permanent magnet flux vector, the stator voltage components are

$${U}_{D} = {RI}_{D} - ω L {I}_{Q} + L \frac{{dI}_{D}}{d t} \qquad ( 6 )$$

$${U}_{Q} = {RI}_{Q} + ω {LI}_{D} + L \frac{{dI}_{Q}}{d t} + ω Ψ \qquad ( 7 )$$

where R and L are the stator resistance and inductance respectively, ω is the mechanical frequency, in other words the rotational speed of the generator, and Ψ is the magnitude of the permanent magnet flux of the generator.

By inserting equation 6 and equation 7 into equation 5 and by simplifying the result, an exact relation between the power of the inverter P_{INVERTER} and the stator current components I_{D}, I_{Q} may be found as

$${P}_{INVERTER} = {RI}_{D}^{2} + \frac{L}{2} \frac{{dI}_{D}^{2}}{d t} + {RI}_{Q}^{2} + \frac{L}{2} \frac{{dI}_{Q}^{2}}{d t} + ωΨ {I}_{Q} \qquad ( 8 )$$

Assuming that resistive losses are insignificant an approximate relation between the power P_{INVERTER} of the inverter and the stator current components I_{D}, I_{Q} it is found that

$${P}_{INVERTER} = \frac{L}{2} \frac{{dI}_{D}^{2}}{d t} + \frac{L}{2} \frac{{dI}_{Q}^{2}}{d t} + ωΨ {I}_{Q} \qquad ( 9 )$$

Assuming that the inverter controls the stator current components I_{D}, I_{Q}, the stator current references are:

$${I}_{D , R E F} = 0 \qquad ( 10 )$$

$${I}_{Q , REF} = - \frac{{K}_{P}}{ω Ψ} ( {U}_{C , R E F}^{2} - {U}_{C}^{2} ) - \frac{{K}_{I}}{ω Ψ} \int ( {U}_{C , R E F}^{2} - {U}_{C}^{2} ) d t \qquad ( 11 )$$

where

$${U}_{C , R E F}^{2}$$

is the reference for the square of the DC-link voltage, K_{P} is the proportional gain and K_{I} is the integral gain.

In practice, a PI-controller may be used to calculate the q-axis stator current reference I_{Q,REF} but for the following analysis the integral part is replaced by its steady state value:

$${I}_{Q , REF} = - \frac{{K}_{P}}{ω Ψ} ( {U}_{C , REF}^{2} - {U}_{C}^{2} ) - \frac{{P}_{L O A D}}{ω Ψ} \qquad ( 12 )$$

Setting the d-axis current reference I_{D,REF} to zero corresponds to traditional MTPA (Maximum Torque Per Ampere) principle. In practice, the d-axis current reference I_{D,REF} may need to be adjusted if maximum output voltage of the inverter is reached. However, for this analysis the d-axis current reference I_{D,REF} is assumed to be constant. Also L, ω, Ψ, P_{LOAD},

$${U}_{C , R E F}^{2}$$

and K_{P} are assumed to be constant. Assuming that in general a stator current controller is much faster than a DC-link voltage controller it is reasonable to assume that the stator current components I_{D}, I_{Q} follow their corresponding references:

$${I}_{D} = {I}_{D , R E F} \qquad ( 13 )$$

$${I}_{Q} = {I}_{Q , REF} \qquad ( 14 )$$

$$\frac{L}{2} \frac{{dI}_{D}^{2}}{d t} = 0 \qquad ( 15 )$$

$$\frac{L}{2} \frac{{dI}_{Q}^{2}}{d t} = \frac{L}{2} \frac{{d ( - \frac{{K}_{P}}{ω Ψ} ( {U}_{C , R E F}^{2} - {U}_{C}^{2} ) - \frac{{P}_{L O A D}}{ω Ψ} )}^{2}}{d t} \qquad ( 16 a )$$

$$\frac{L}{2} \frac{{dI}_{Q}^{2}}{d t} = L \frac{{K}_{P}}{ω Ψ} ( - \frac{{K}_{P}}{ω Ψ} ( {U}_{C , R E F}^{2} - {U}_{C}^{2} ) - \frac{{P}_{L O A D}}{ω Ψ} ) \frac{d {U}_{C}^{2}}{d t} \qquad ( 16 b )$$

By inserting equation 15 and equation 16b into equation 9 and by simplifying a relation between the power of the inverter P_{INVERTER} and the square of the DC-link voltage it is found that

$${P}_{INVERTER} = L \frac{{K}_{P}}{ω Ψ} ( - \frac{{K}_{P}}{ω Ψ} ( {U}_{C , REF}^{2} - {U}_{C}^{2} ) - \frac{{P}_{L O A D}}{ω Ψ} ) \frac{d {U}_{C}^{2}}{d t} - {K}_{P} ( {U}_{C , REF}^{2} - {U}_{C}^{2} ) - {P}_{LOAD} \qquad ( 17 )$$

By inserting equation 17 into equation 4 and by simplifying a relation between the power of the DC-link and the square of the DC-link voltage it is found that

$${P}_{C} = - L \frac{{K}_{P}}{ω Ψ} ( - \frac{{K}_{P}}{ω Ψ} ( {U}_{C , R E F}^{2} - {U}_{C}^{2} ) - \frac{{P}_{L O A D}}{ω Ψ} ) \frac{d {U}_{C}^{2}}{d t} + {K}_{P} ( {U}_{C , R E F}^{2} - {U}_{C}^{2} ) \qquad ( 18 )$$

By inserting equation 18 into equation 3 and by simplifying an equation describing the dynamics of the DC-link voltage control it is found that

$$\frac{d {U}_{C}^{2}}{d t} = \frac{{K}_{P} ( {U}_{C , REF}^{2} - {U}_{C}^{2} )}{\frac{C}{2} + L \frac{{K}_{P}}{ω Ψ} ( - \frac{{K}_{P}}{ω Ψ} ( {U}_{C , REF}^{2} - {U}_{C}^{2} ) - \frac{{P}_{L O A D}}{ω Ψ} )} \qquad ( 19 )$$

In order to analyze the stability of the DC-link voltage control the equation can be linearized around the steady state operation point:

$$\frac{d {U}_{C}^{2}}{d t} ( {U}_{C}^{2} ) = f ( {U}_{C}^{2} ) \qquad ( 20 )$$

$$\frac{d {U}_{C}^{2}}{d t} ( {U}_{C}^{2} ) \approx f ( {U}_{C , R E F}^{2} ) + \frac{d f ( {U}_{C , R E F}^{2} )}{d {U}_{C}^{2}} ( {U}_{C}^{2} - {U}_{C , R E F}^{2} ) \qquad ( 21 )$$

$$\frac{d {U}_{C}^{2}}{d t} ( {U}_{C}^{2} ) \approx \frac{- {K}_{P}}{\frac{C}{2} - L \frac{{K}_{P}}{ωΨ} \frac{{P}_{L O A D}}{ωΨ}} ( {U}_{C}^{2} - {U}_{C , R E F}^{2} ) \qquad ( 22 )$$

From equation 22 it is evident that in order to maintain stability the proportional gain will need to be limited according to

$${K}_{P} < \frac{1}{2} \frac{C}{L} \frac{{( ω Ψ )}^{2}}{{P}_{L O A D}} \qquad ( 23 )$$

Consequently, with the conventional approaches, a high proportional gain cannot be used at high load, particularly when the inductance L is large or when capacitance C is small. For example, when the small capacitance C may range from 1.0 to 2.0 p.u. and the large inductance L ranges from 0.5 to 1.0 p.u., given a load power P_{LOAD} in a range from 0.5 to. 1.0 p.u. and back-emf ωΨ in a range from 0.5 to 1.0 p.u., without the method in the present application the maximum gain varies according to equation 23 in a range from 0.125 to 2.0 p.u. This is a well-known issue also with grid connected inverters that are supplying the DC-link from a weak grid corresponding to a high inductance L in equation 23. In contrast, with the inventive method proposed in the present application a constant gain of e.g. 2.0 p.u. always can be used. It has to be mentioned in this context that without the present disclosure the maximum gain heavily depends on the load power P_{LOAD}, the inductance L, the capacitance C, the speed ω and the permanent magnet flux Ψ. Therefore, it is not sensible to provide concrete and/or absolute values of the corresponding parameters in their specific units. Therefore, the expression “p.u.”, i.e., “per unit”, is used in the above example.

### BRIEF DESCRIPTION

It is an objective of the present disclosure to provide a method, a controller, and a computer program for operating an inverter for driving a generator, which enable to use a high proportional gain, in particular at high load, in particular when a stator inductance L of the generator is large and/or when a capacitance C of a DC-link capacitor of the inverter is small. It is another objective of the present disclosure to provide an inverter system comprising the controller and the inverter. It is another objective of the present disclosure to provide a computer-readable medium on which the computer program is stored.

These objectives are achieved by the subject-matter of the independent claims. Further exemplary embodiments are evident from the dependent claims and the following description.

A first aspect relates to a method for operating an inverter for driving a generator. The inverter comprises a DC-link having a DC-link capacitor. The inverter is configured for converting a three-phase AC voltage generated by the generator into a DC-link voltage to be applied to the DC-link capacitor. The method comprises: receiving a DC-link voltage reference to be applied to the DC-link; receiving an actual DC-link voltage currently being present over the DC-link; determining a stator parameter reference depending on the received DC-link voltage reference and on the received actual DC-link voltage; modifying the determined stator parameter reference by adding a dynamic stabilizing term to the stator parameter reference; generating a switching signal for the inverter depending on the modified stator parameter reference; and operating the inverter by supplying the switching signal to the inverter.

A second aspect relates to a controller for operating the inverter. The controller comprises a memory for storing one or more measured, determined, and/or predetermined current and/or voltage values, and a processor communicatively coupled to the memory and being configured to carry out the method as described above and in the following.

A third aspect relates to an inverter system. The inverter system comprises the inverter for driving the generator and the controller for operating the inverter.

A fourth aspect relates to a computer program for operating the inverter for driving the generator. The computer program comprises computer-readable instructions which, when being executed by the processor of the controller, carry out the method as described above an in the following.

A fifth aspect relates to a computer-readable medium on which the computer program is stored. The computer-readable medium may be a floppy disk, a hard disk, an USB (Universal Serial Bus) storage device, a RAM (Random Access Memory), a ROM (Read Only Memory), an EPROM (Erasable Programmable Read Only Memory) or a FLASH memory. The computer readable medium may also be a data communication network, e.g. the Internet, which allows downloading a program code. In general, the computer-readable medium may be a non-transitory or transitory medium.

It has to be understood that some features of the present disclosure are described with respect to one of the aspects only for conciseness reasons and to avoid unnecessary repetitions, but that these features may be easily transferred to one or more of the other aspects by the person skilled in the art.

The proposed aspects involve adding the dynamic stabilizing term into any stator parameter reference, e.g., a stator current reference or a stator flux reference, in order to allow for higher proportional gain, in particular at high load. So, the above aspects enable to set stator parameter references for the generator such that high performance DC-link voltage control is possible. In particular, higher proportional gain and thus faster response compared to traditional MTPA principle is possible.

The method may be carried out by the controller for controlling the inverter. The DC-link voltage reference may be predetermined and/or may be sent to the controller by an external device. The external device may be external with respect to the controller and with respect to the inverter. The actual DC-link voltage may be measured, e.g., by a voltage sensor of the inverter.

The inverter may comprise two or more, e.g., six, semiconductor switches for converting the AC-voltage into the DC-link voltage. The switching signal may comprise switching commands for the semiconductor switches. When generating the switching signal, timing limitations of the semiconductor switches, such as an interlocking time and/or a minimal on/off time of the semiconductor switches, may be considered. The switching signal, in particular the switching commands, then may be translated into gate voltages for controlling the semiconductor switches, as it is known in the art. The inverter may be a two-level voltage source inverter or a three-level voltage source inverter, for example.

According to an embodiment, when determining the stator parameter reference, a d-axis stator parameter reference and a q-axis stator parameter reference are determined, and the dynamic stabilizing term is added to at least one of the stator parameter references.

According to an embodiment, the dynamic stabilizing term is added to the d-axis stator parameter reference.

According to an embodiment, the method comprises, before adding the dynamic stabilizing term to the stator parameter reference: determining the dynamic stabilizing term such that an electric energy needed to change an actual current generated by the generator and corresponding to actual stator currents or actual stator fluxes is minimized.

According to an embodiment, when determining the dynamic stabilizing term such that the electric energy needed to change the actual stator parameter is minimized, the dynamic stabilizing term is determined such that a change of the electric energy stored in the actual stator currents or the actual stator fluxes corresponding to the actual current generated by the generator is minimized.

According to an embodiment, the dynamic stabilizing term is determined such that

$$\frac{L}{2} \frac{{dI}_{D , REF}^{2}}{d t} + \frac{L}{2} \frac{{dI}_{Q , REF}^{2}}{d t} = 0$$

$$or$$

$$\frac{1}{2 L} \frac{d {Ψ}_{D , REF}^{2}}{d t} + \frac{1}{2 L} \frac{d {Ψ}_{Q , REF}^{2}}{dt} = 0$$

with L being a stator inductance of a stator of the generator, in particular if the generator is a permanent magnet generator. However, for other types of generators similar equations may be found for determining the dynamic stabilizing term such that the electric energy needed to change the actual current, in particular the actual stator currents or the actual stator flux, is minimized.

According to an embodiment, the method comprises: before determining the stator parameter reference, determining a rotational speed of the generator and determining the stator parameter reference depending on the rotational speed of the generator. The rotational speed may be measured, e.g., by an encoder, and may be sent to a controller for controlling the inverter. Alternatively, the rotational speed may be estimated from an output voltage and from an output current of the inverter by the controller or by a flux observer known in the art and used to obtain the rotational speed.

According to an embodiment, the method comprises: receiving an actual stator current generated by the generator; determining a stator voltage reference corresponding to the three-phase AC voltage to be generated by the generator depending on the actual stator current and on the modified stator parameter reference; and generating the switching signal depending on the modified stator parameter reference by generating the switching signal depending on the determined stator voltage reference. The stator voltage reference may comprise two stator voltage reference components, e.g., a d-axis voltage reference component and a q-axis voltage reference component. The d-axis voltage reference component and the q-axis voltage reference component in the dq-frame may be transferred into three voltage reference components in a uvw-frame (corresponding to the abc-frame), i.e., an u-phase voltage reference component, a v-phase voltage reference component and a w-phase voltage reference component, e.g., by an inverse space vector transformation. Then, the switching signal may be determined depending on the three voltage reference components in the uvw-frame. When transferring the voltage reference components in the dq-frame into the voltage reference components in the uvw-frame, an actual angle of the stator may be considered. The actual angle may be measured by an appropriate sensor, e.g., a hall-sensor, or may be estimated, e.g., by the controller.

According to an embodiment, the method comprises, after receiving the actual stator current and before determining the stator voltage reference: determining the actual d-axis stator current and an actual q-axis current from the actual stator current, and determining the stator voltage reference depending on the actual d-axis stator current and the actual q-axis current and on the modified stator parameter reference. The actual stator current may be measured by a current sensor of the generator or may be estimated by the controller. The actual d-axis stator current and the actual q-axis stator current may be determined from the actual stator current by a space vector transformation. Optionally, an actual d-axis stator flux and an actual q-axis stator flux may be determined from the actual d-axis stator current and the actual q-axis stator current. In this case, the stator voltage reference may be determined depending on the actual d-axis stator flux and the actual q-axis stator flux and on the modified stator parameter reference.

According to an embodiment, the stator parameter reference is the stator current reference or the stator flux reference. In particular, the stator current reference may be a d-axis or a q-axis stator current reference, or the stator current reference may be a d-axis or a q-axis stator flux reference, respectively.

These and other aspects of the present disclosure will be apparent from and elucidated with reference to the embodiments described hereinafter.

### BRIEF DESCRIPTION OF DRAWINGS

The subject matter of the present disclosure will be explained in more detail in the following text with reference to exemplary embodiments which are illustrated in the attached drawings.

FIG. 1 shows an example of an inverter for driving a generator.

FIG. 2 shows an exemplary embodiment of a controller for operating an inverter.

FIG. 3 shows an exemplary embodiment of a controller for operating an inverter.

The reference symbols used in the drawings, and their meanings, are listed in summary form in the list of reference symbols. In principle, identical parts are provided with the same reference symbols in the figures.

### DETAILED DESCRIPTION

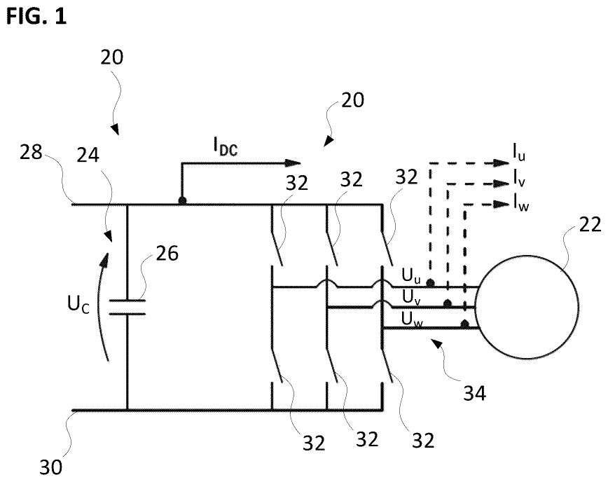

FIG. 1 shows an inverter 20, in particular an electrical inverter. The inverter 20 is electrically coupled to a generator 22. The inverter 20 is configured for driving the generator 22. The generator 22 is configured for generating a three-phase AC voltage.

The inverter 20 comprises a DC-link 24 having a DC-link capacitor 26, a first DC-terminal 28, a second DC-terminal 30, a set of semiconductor switches 32, e.g. six semiconductor switches 32, and an AC-terminal 34. The inverter 20 is a two-level voltage source inverter. However, in an alternative embodiment, a three-level voltage source inverter may be used, for example.

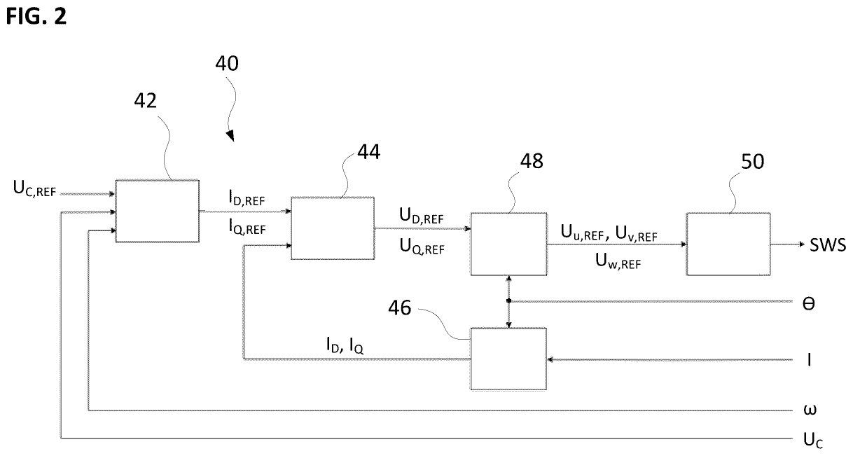

The AC-terminal 34 is coupled to the generator 22. The AC-terminal 34 is configured for receiving the three-phase AC voltage generated by the generator 22. The semiconductor switches 32 are configured for converting the three-phase AC voltage into a DC voltage, in particular a DC-link voltage, applied to the DC-link capacitor 26. To this end, the semiconductor switches 32, in particular gates of the semiconductor switches 32, are coupled to a controller 40 (see FIG. 2) for controlling the inverter 20.

The three-phase AC voltage consists of a phase u voltage Uᵤ, a phase v voltage Uᵥ, and a phase w voltage U_{w} applied to the AC-terminal 34 by the generator 22. As a result, the generator 22 feeds a three-phase current into the AC-terminal 34. The three-phase current consists of a phase u current Iᵤ, a phase v current Iᵥ, and a phase w current I_{w}.

The three-phase AC voltage is converted by the semiconductor switches 32 into an actual DC-link voltage U_{C} resulting over the DC-link capacitor 26. This enables to feed a corresponding DC current I_{DC} to the external device.

The DC-terminals 28, 30 are configured for being connected to a DC device (not shown) or to a DC grid (not shown). The first DC-terminal 28 may be coupled to a positive potential of the DC device and the second DC-terminal 30 may be coupled to a negative potential of the DC device. The DC device may be external with respect to the inverter 20. The DC device may be a rechargeable battery or a DC grid. The inverter 20 and the generator 22 may be arranged in a ship. In this case, the DC grid may be a DC grid of the ship. Alternatively, the inverter 20 and the generator 22 may be arranged in an electric vehicle, such as a train or subway. Alternatively, the generator 22 may be a wind turbine.

The inverter 20 may comprise one or more components to measure a current space vector, e.g., depending on the phase u current Iᵤ, the phase v current Iᵥ, and the phase w current I_{w} or by using actual states of the switches 32 and the DC-link current I_{DC}, and/or to measure the actual DC-link voltage U_{C}. These component(s) may be one or more current and/or, respectively, voltage sensors (not shown).

FIG. 2 shows an exemplary embodiment of the controller 40 for operating an inverter, e.g., the inverter 20 of FIG. 1. The controller 40 may comprise a DC voltage controller 42, a current controller 44, a first transformation block 46, a second transformation block 48, and a modulator 50. In addition, the controller 40 comprises a memory (not shown) for storing one or more measured, determined, and/or predetermined current and/or voltage values, and a processor (not shown) communicatively coupled to the memory and being configured to carry out a method for operating the inverter 20, as described in the following.

A DC-link voltage reference U_{C,REF} to be applied to the DC-link 24 may be received by the controller 40, in particular by the DC voltage controller 42. The DC-link voltage reference U_{C,REF} may be predetermined and/or may be generated by the external device. The external device may be external with respect to the controller 40 and with respect to the inverter 20.

In addition, the actual DC-link voltage U_{C} currently being present over the DC-link 26 may be received by the controller 40, in particular by the DC voltage controller 42. The actual DC-link voltage U_{C} may be measured, e.g., by a voltage sensor (not shown) of the inverter 20.

A stator parameter reference, e.g., a stator current reference I_{D,REF}, I_{Q,REF} corresponding to a stator current to be generated by the generator 22 may be determined depending on the received DC-link voltage reference U_{C,REF} and on the received actual DC-link voltage U_{C}, e.g., by the DC voltage controller 42. When determining the stator current reference I_{D,REF}, I_{Q,REF}, a d-axis stator current reference I_{D,REF} and a q-axis stator current reference I_{Q,REF} may be determined. The DC voltage controller 42 may have a control law for regulating a DC voltage level at the DC-link 24.

Optionally, before determining the stator current reference I_{D,REF}, I_{Q,REF}, a rotational speed ω of the generator 22 may be determined. In this case, the stator current reference I_{D,REF}, I_{Q,REF} may be determined depending on the rotational speed ω of the generator 22 also. The rotational speed ω may be measured, e.g., by an encoder (not shown), and may be sent to the controller 40. Alternatively, the rotational speed ω may be estimated from an output voltage Uᵤ, Uᵥ, U_{w}, and from an output current Iᵤ, Iᵥ, I_{w}, of the inverter by the controller 40 or by a flux observer (not shown) known in the art and used to obtain the rotational speed ω.

Before sending the determined stator current reference I_{D,REF}, I_{Q,REF} to the current controller 44, the determined stator current reference I_{D,REF}, I_{Q,REF} may be modified by adding a dynamic stabilizing term to the stator current reference I_{D,REF}, I_{Q,REF}. The dynamic stabilizing term may be added to at least one of the stator current references I_{D,REF}, I_{Q,REF}. For example, the dynamic stabilizing term may be added to the d-axis stator current reference I_{D,REF}. The current controller 44 may have a control law for regulating the inverter current to a value defined by the determined stator current reference I_{D,REF}, I_{Q,REF} coming from the DC voltage controller 42.

The dynamic stabilizing term may be determined such that the variation in the energy stored in the magnetic field of the generator 22 and corresponding to actual stator currents I_{D}, I_{Q} is minimized. In particular, in order to allow for high proportional gain at high load the stator current reference I_{D,REF}, I_{Q,REF}, e.g., the d-axis stator current reference I_{D,REF}, may be chosen such that the energy needed to change actual stator current components I_{D}, I_{Q} is minimized:

$$\frac{L}{2} \frac{{dI}_{D , REF}^{2}}{d t} + \frac{L}{2} \frac{{dI}_{Q , REF}^{2}}{d t} = 0 \qquad ( 24 )$$

with L being a stator inductance of a stator of the generator 22.

Assuming a slowly changing integral term condition 24 can be satisfied, for example, with

$${I}_{D , R E F} = - \sqrt{{I}_{0}^{2} - \frac{{K}_{P}}{ω Ψ} ( {U}_{C , R E F}^{2} - {U}_{C}^{2} ) ( \frac{{K}_{P}}{ω Ψ} ( {U}_{C , R E F}^{2} - {U}_{C}^{2} ) + 2 \frac{{K}_{I}}{ω Ψ} \int ( {U}_{C , R E F}^{2} - {U}_{C}^{2} ) d t )} \qquad ( 25 )$$

where I₀ is the d-axis stator current reference in steady state. However, any other dynamic stabilizing term fulfilling the requirement of equation 24 may be used.

For the following analysis the integral part of equation 25 is replaced by its steady state value

$${I}_{D , R E F} = - \sqrt{{I}_{0}^{2} - \frac{{K}_{P}}{ω Ψ} ( {U}_{C , R E F}^{2} - {U}_{C}^{2} ) ( \frac{{K}_{P}}{ω Ψ} ( {U}_{C , R E F}^{2} - {U}_{C}^{2} ) + 2 \frac{{P}_{L O A D}}{ω Ψ} )} \qquad ( 26 )$$

Assuming that the current controller 44 is much faster than the DC-link voltage controller 42, in other words that the current control is much faster than DC-link voltage control, it is reasonable to assume that the stator current components I_{D}, I_{Q} follow their corresponding references:

$${I}_{D} = {I}_{D , R E F} \qquad ( 27 )$$

$$\frac{L}{2} \frac{{dI}_{D}^{2}}{d t} = \frac{L}{2} \frac{d ( {I}_{0}^{2} - \frac{{K}_{P}}{ω Ψ} ( {U}_{C , R E F}^{2} - {U}_{C}^{2} ) ( \frac{{K}_{P}}{ω Ψ} ( {U}_{C , R E F}^{2} - {U}_{C}^{2} ) + 2 \frac{{P}_{L O A D}}{ω Ψ} ) )}{d t} \qquad ( 28 a )$$

$$\frac{L}{2} \frac{{dI}_{D}^{2}}{d t} = L \frac{{K}_{P}}{ω Ψ} ( \frac{{K}_{P}}{ω Ψ} ( {U}_{C , R E F}^{2} - {U}_{C}^{2} ) + \frac{{P}_{L O A D}}{ω Ψ} ) \frac{d {U}_{C}^{2}}{d t} \qquad ( 28 b )$$

By inserting equation 16b and equation 28b into equation 9 and by simplifying a relation between the power of the inverter and the square of the DC-link voltage it is found that

$${P}_{INVENTER} = - {K}_{P} ( {U}_{C , R E F}^{2} - {U}_{C}^{2} ) - {P}_{LOAD} \qquad ( 29 )$$

By inserting equation 29 into equation 4 and by simplifying a relation between the power of the DC-link and the square of the DC-link voltage it is found that

$${P}_{C} = {K}_{P} ( {U}_{C , R E F}^{2} - {U}_{C}^{2} ) \qquad ( 30 )$$

By inserting equation 30 into equation 3 and by simplifying an equation describing the dynamics of the DC-link voltage control it is found that

$$\frac{d {U}_{C}^{2}}{d t} = \frac{- 2 {K}_{P}}{C} ( {U}_{C}^{2} - {U}_{C , R E F}^{2} ) \qquad ( 31 )$$

From equation 31 it is evident that stability is maintained even if the proportional gain is set to higher values than suggested by equation 23. Therefore, higher performance for the DC-link voltage control is possible. It should be noted that similar results can be achieved with alternative forms of equation 25 for the d-axis stator current reference I_{D,REF}. Therefore, the present disclosure is not restricted to this form of the equation but to the principle of adding the dynamic stabilizing term to the corresponding current reference in order to allow for higher proportional gain.

It has to be noted that the steady state d-axis current reference I₀ mentioned above may be chosen such that equation 25 gives a negative real value rather than an imaginary value. Once equation 25 goes imaginary the d-axis current reference could be set to zero or some other constant value and the proportional gain K_{P} could be reduced to avoid instability. The steady state d-axis current reference I₀ may be chosen such that the dynamic performance requirements for the corresponding application are fulfilled at every operation point. For example, at full load the steady state d-axis current reference I₀ may be reduced since load cannot increase anymore.

An actual stator current I generated by the generator 22 may be received by the controller 40, in particular by the current controller 44. The actual stator current I may be measured by a current sensor (not shown) or may be estimated by the controller 40. The current sensor may be a component of the generator 22. Then, a stator voltage reference U_{D,REF}, U_{Q,REF} corresponding to the three-phase AC voltage Uᵤ, Uᵥ, U_{w} to be generated by the generator 22 may be determined depending on the actual stator current I and on the modified stator current reference I_{D,REF}, I_{Q,REF}, e.g. by the current controller 44.

After receiving the actual stator current I and before determining the stator voltage reference U_{D,REF}, U_{Q,REF} an actual d-axis stator current I_{D} and an actual q-axis current I_{Q} may be determined from the actual stator current I. In this case, the stator voltage reference U_{D,REF}, U_{Q,REF} may be determined depending on the actual d-axis stator current I_{D}, the actual q-axis current I_{Q}, and on the modified stator current reference I_{D,REF}, I_{Q,REF}. The actual d-axis stator current I_{D} and the actual q-axis stator current I_{Q} may be determined from the actual stator current I by a space vector transformation, for example being carried out by the first transformation block 46. In general, a space vector transformation may be used to transform signals from three-phase signals into space vector rotating in synchronous coordinates by utilizing Park and Clarke transformations.

The stator voltage reference U_{D,REF}, U_{Q,REF} may comprise two stator voltage reference components, e.g., a d-axis voltage reference component U_{D,REF} and a q-axis voltage reference component U_{Q,REF}. The d-axis voltage reference component U_{D,REF} and the q-axis voltage reference component U_{Q,REF} in the dq-frame may be transferred into three voltage reference components in the uvw-frame, i.e., an u-phase voltage reference component U_{u,REF}, a v-phase voltage reference component U_{v,REF} and a w-phase voltage reference component U_{w,REF}, e.g., by an inverse space vector transformation which may be carried out by the second transformation block 48. When transferring the stator voltage references U_{D,REF}, U_{Q,REF} in the dq-frame into the three-phase voltage reference components U_{u,REF}, U_{v,REF}, U_{w,REF} in the uvw-frame, an actual angle θ of the stator may be considered, in particular within the first and/or second transformation block 46, 48. The actual angle θ may be measured by an appropriate sensor, e.g., a hall-sensor, or may be estimated, e.g., by the controller 40.

Then, a switching signal SWS for the inverter 40 may be generated depending on the modified stator current reference I_{D,REF}, I_{Q,REF}, e.g., by the modulator 50. The switching signal SWS may be determined depending on the modified stator current reference I_{D,REF}, I_{Q,REF} by generating the switching signal depending on the determined stator voltage reference U_{D,REF}, U_{Q,REF}, e.g., by the three voltage reference components U_{u,REF}, U_{v,REF}, U_{w,REF} in the uvw-frame. The switching signal SWS may comprise switching commands for the semiconductor switches 32. When generating the switching signal SWS, timing limitations of the semiconductor switches 32, such as an interlocking time and/or a minimal on/off time of the semiconductor switches 32, may be considered. The switching signal SWS, in particular the switching commands, then may be translated into gate voltages for controlling the semiconductor switches 32, as it is known in the art. So, the modulator 50 translates the voltage reference components U_{u,REF}, U_{v,REF}, U_{w,REF} into gate driver signals in a semiconductor bridge comprising the semiconductor switches 32, which will then realize the corresponding three-phase AC voltage on average over a switching cycle of the inverter 20.

Finally, the inverter 20 may be operated by the controller 40 by supplying the switching signal SWS to the inverter 20, in particular to the gates of the semiconductor switches 32.

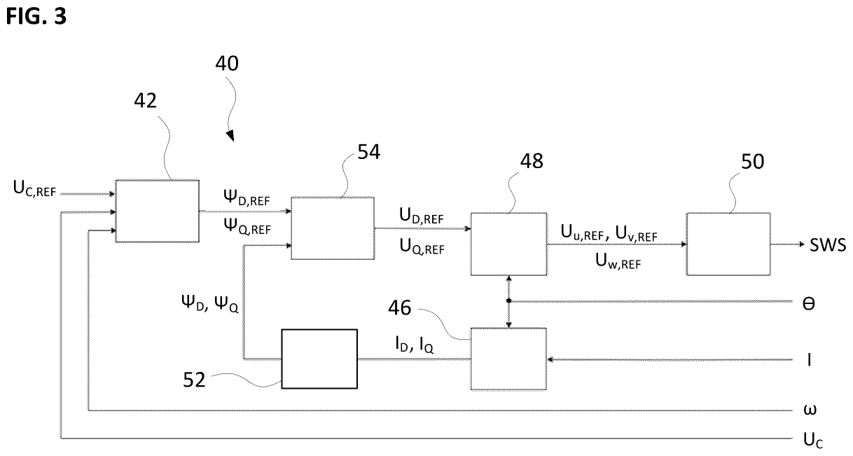

FIG. 3 shows an exemplary embodiment of a controller 40 for operating an inverter, e.g. for operating the inverter 20 of FIG. 1. The controller 40 shown in FIG. 3 may widely correspond to the controller 40 described with respect to FIG. 2. Therefore, in order to provide a concise description and to avoid any unnecessary repetitions, only those features of the controller 40 of FIG. 3 are described in the following in which the controller of FIG. 3 differs from the controller of FIG. 2.

The controller 40 may comprise a flux controller 54 instead of the current controller 44. In this case, the controller 40 may comprise a flux calculator 52.

Another stator parameter reference, e.g., a stator flux reference Ψ_{D,REF}, Ψ_{Q,REF} corresponding to a stator flux to be generated by the generator 22 may be determined depending on the received DC-link voltage reference U_{C,REF} and on the received actual DC-link voltage U_{C}, e.g., by the DC voltage controller 42. When determining the stator flux reference Ψ_{D,REF}, Ψ_{Q,REF}, a d-axis stator flux reference Ψ_{D,REF} and a q-axis stator flux reference Ψ_{Q,REF} may be determined. When the rotational speed ω is determined, the stator flux reference Ψ_{D,REF}, Ψ_{Q,REF} may be determined depending on the rotational speed ω also.

Before sending the determined stator flux reference Ψ_{D,REF}, Ψ_{Q,REF} to the flux controller 54, the determined stator flux reference Ψ_{D,REF}, Ψ_{Q,REF} may be modified by adding a dynamic stabilizing term to the stator flux reference Ψ_{D,REF}, Ψ_{Q,REF}. The dynamic stabilizing term may be added to at least one of the stator flux references Ψ_{D,REF}, Ψ_{Q,REF}. For example, the dynamic stabilizing term may be added to the d-axis stator flux reference Ψ_{D,REF}. The flux controller 54 may have a control law for regulating the inverter current to a value defined by the determined stator flux reference Ψ_{D,REF}, Ψ_{Q,REF} coming from the DC voltage controller 42.

The dynamic stabilizing term may be determined such that the variation in the energy stored in the magnetic field of the generator 22 and corresponding to actual stator currents I_{D}, I_{Q} or to actual stator fluxes Ψ_{D}, Ψ_{Q} is minimized, wherein the actual stator fluxes Ψ_{D}, Ψ_{Q} may be determined from the actual stator currents I_{D}, I_{Q} by the flux calculator 52, as it is known in the art. In particular, in order to allow for high proportional gain at high load the stator flux reference Ψ_{D,REF}, Ψ_{Q,REF}, e.g., the d-axis stator flux reference Ψ_{D,REF}, may be chosen such that the energy needed to change actual stator flux components Ψ_{D}, Ψ_{Q} is minimized:

$$\frac{1}{2 L} \frac{d Ψ {I}_{D , REF}^{2}}{dt} + \frac{1}{2 L} \frac{d {Ψ}_{Q , REF}^{2}}{d t} = 0$$

with L being the stator inductance of the stator of the generator 22.

An inverter system comprises the inverter 20 for driving the generator 22 and the controller 40 for operating the inverter 20.

A computer program for operating the inverter 20 for driving the generator 22 may be provided. The computer program may comprise computer-readable instructions which, when being executed by the processor of the controller 40, carry out the method as described above. The computer program may be stored on a computer-readable medium. The computer-readable medium may be a floppy disk, a hard disk, an USB (Universal Serial Bus) storage device, a RAM (Random Access Memory), a ROM (Read Only Memory), an EPROM (Erasable Programmable Read Only Memory) or a FLASH memory. The computer readable medium may also be a data communication network, e.g. the Internet, which allows downloading a program code. In general, the computer-readable medium may be a non-transitory or transitory medium.

While the present disclosure has been illustrated and described in detail in the drawings and foregoing description, such illustration and description are to be considered illustrative or exemplary and not restrictive; the present disclosure is not limited to the disclosed embodiments. Other variations to the disclosed embodiments can be understood and effected by those skilled in the art and practicing the claimed subject matter, from a study of the drawings, the disclosure, and the appended claims. In the claims, the word “comprising” does not exclude other elements or steps, and the indefinite article “a” or “an” does not exclude a plurality. A single processor or controller or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

1. A method for operating an inverter for driving a generator, the inverter comprising a direct current link (DC-link) having a DC-link capacitor and the inverter configured to convert a three-phase alternating current (AC) voltage generated by the generator into a DC-link voltage to be applied to the DC-link capacitor, the method comprising:
receiving a DC-link voltage reference to be applied to the DC-link;
receiving an actual DC-link voltage currently present over the DC-link;
determining a stator parameter reference based on the received DC-link voltage reference and the received actual DC-link voltage;
modifying the determined stator parameter reference by adding a dynamic stabilizing term to the stator parameter reference;
generating a switching signal for the inverter based on the modified stator parameter reference; and
operating the inverter by supplying the switching signal to the inverter.

2. The method according to claim 1, wherein:
when determining the stator parameter reference, a d-axis stator parameter reference and a q-axis stator parameter reference are determined, and
the dynamic stabilizing term is added to at least one term of the stator parameter reference.

3. The method according to claim 2, wherein:
the dynamic stabilizing term is added to the d-axis stator parameter reference.

4. The method according to claim 1, wherein before adding the dynamic stabilizing term to the stator parameter reference, the method further comprises:
determining the dynamic stabilizing term such that an electric energy needed to change an actual current generated by the generator and corresponding to actual stator currents or actual stator fluxes is minimized.

5. The method according to claim 4, wherein:
when determining the dynamic stabilizing term such that the electric energy needed to change the actual current is minimized, the dynamic stabilizing term is determined such that a change of the electric energy stored in the actual stator currents or the actual stator fluxes corresponding to the actual current generated by the generator is minimized.

6. The method according to claim 5, wherein:
the dynamic stabilizing term is determined such that
$$\frac{L}{2} \frac{{dI}_{D , REF}^{2}}{d t} + \frac{L}{2} \frac{{dI}_{Q , REF}^{2}}{d t} = 0$$
$$and / or$$
$$\frac{1}{2 L} \frac{d {Ψ}_{D , REF}^{2}}{d t} + \frac{1}{2 L} \frac{d {Ψ}_{Q , REF}^{2}}{dt} = 0$$
wherein L comprises a stator inductance of a stator of the generator.

7. The method according to claim 1, further comprising:
before determining the stator parameter reference, determining a rotational speed of the generator; and
determining the stator parameter reference based on the rotational speed of the generator.

8. The method according to claim 1, further comprising:
receiving an actual stator current generated by the generator;
determining a stator voltage reference corresponding to the three-phase AC voltage generated by the generator based on the actual stator current and the modified stator parameter reference; and
generating the switching signal based on the modified stator parameter reference by generating the switching signal based on the determined stator voltage reference.

9. The method according to claim 8, after receiving the actual stator current and before determining the stator voltage reference, the method further comprises:
determining an actual d-axis stator current and an actual q-axis stator current from the actual stator current; and
determining the stator voltage reference based depending on the actual d-axis stator current, the actual q-axis current, and the modified stator parameter reference.

10. The method according to claim 1, wherein:
the stator parameter reference comprises a stator current reference or a stator flux reference.

11. A controller configured to operate an inverter to drive a generator, the inverter comprising a direct current link (DC-link) having a DC-link capacitor, wherein the inverter is configured to convert a three-phase alternating current (AC) voltage generated by the generator into a DC-link voltage to be applied to the DC-link capacitor, the controller comprising:
a memory configured to store one or more measured, determined, and/or predetermined current and/or voltage values; and
at least one processor communicatively coupled to the memory, the at least one processor configured to:
receive a DC-link voltage reference to be applied to the DC-link;
receive an actual DC-link voltage currently present over the DC-link;
determine a stator parameter reference based on the received DC-link voltage reference and the received actual DC-link voltage;
modify the determined stator parameter reference by adding a dynamic stabilizing term to the stator parameter reference;
generate a switching signal for the inverter based on the modified stator parameter reference; and
operate the inverter by supplying the switching signal to the inverter.

12. An inverter system, comprising:
the controller according to claim 11; and
an inverter configured to drive a generator, the inverter including the DC-link having the DC-link capacitor, wherein the inverter is configured to convert the three-phase AC voltage generated by the generator into the DC-link voltage to be applied to the DC-link capacitor.

13. The controller of claim 11, wherein:
the at least one processor is further configured to determine a d-axis stator parameter reference and a q-axis stator parameter reference when determining the stator parameter reference, and
the at least one processor is further configured to add the dynamic stabilizing term to at least one of the stator parameter references.

14. The controller of claim 13, wherein the at least one processor is further configured to add the dynamic stabilizing term to the d-axis stator parameter reference.

15. The controller of claim 11, wherein the at least one processor is further configured, before adding the dynamic stabilizing term to the stator parameter reference, to:
determine the dynamic stabilizing term such that an electric energy needed to change an actual current generated by the generator and corresponding to actual stator currents or actual stator fluxes is minimized.

16. The controller of claim 15, wherein the at least one processor is further configured, when determining the dynamic stabilizing term such that the electric energy needed to change the actual current is minimized to:
determine the dynamic stabilization term such that a change of the electric energy stored in the actual stator currents or the actual stator fluxes corresponding to the actual current generated by the generator is minimized.

17. The controller of claim 16, wherein:
the dynamic stabilizing term is determined such that
$$\frac{L}{2} \frac{{dI}_{D , REF}^{2}}{d t} + \frac{L}{2} \frac{{dI}_{Q , REF}^{2}}{d t} = 0$$
$$and / or$$
$$\frac{1}{2 L} \frac{d {Ψ}_{D , REF}^{2}}{d t} + \frac{1}{2 L} \frac{d {Ψ}_{Q , REF}^{2}}{dt} = 0$$
and L comprises a stator inductance of a stator of the generator.

18. The controller of claim 11, wherein the at least one processor is further configured, before determining the stator parameter reference, to:
determine a rotational speed of the generator; and
determine the stator parameter reference based on the rotational speed of the generator.

19. The controller of claim 11, wherein the at least one processor is further configured to:
receive an actual stator current generated by the generator;
determine a stator voltage reference corresponding to the three-phase AC voltage generated by the generator based on the actual stator current and the modified stator parameter reference; and
generate the switching signal based on determined stator voltage reference.

20. A non-transitory computer-readable medium embodying programmed instructions which, when executed by at least one processor of a controller configured to operate an inverter to drive a generator, the inverter comprising a direct current link (DC-link) having a DC-link capacitor, wherein the inverter is configured to convert a three-phase alternating current (AC) voltage generated by the generator into a DC-link voltage to be applied to the DC-link capacitor, direct the at least one processor to:
receive a DC-link voltage reference to be applied to the DC-link;
receive an actual DC-link voltage currently present over the DC-link;
determine a stator parameter reference based on the received DC-link voltage reference and the received actual DC-link voltage;
modify the determined stator parameter reference by adding a dynamic stabilizing term to the stator parameter reference;
generate a switching signal for the inverter based on the modified stator parameter reference; and
operate the inverter by supplying the switching signal to the inverter.
